(19) United States
(12) Patent Application Publication
(10) Pub. No.: US 2012/0050215 A1
(43) Pub. Date: Mar. 1, 2012

(54) TOUCH SCREEN

(75) Inventors: Sang Hwa Kim, Gyunggi-do (KR); Jong Young Lee, Gyunggi-do (KR)

(73) Assignee: SAMSUNG ELECTRO-MECHANICS CO., LTD., Suwon, Gyunggi-do (KR)

(21) Appl. No.: 12/984,888

(22) Filed: Jan. 5, 2011

(30) Foreign Application Priority Data
Aug. 30, 2010 (KR) 1020100084353

(51) Int. Cl. G06F 3/045

(52) U.S. Cl. 345/174

(57) ABSTRACT

Disclosed herein is a touch screen. The touch screen includes: two sheets of transparent substrates formed to be opposite to each other; transparent electrodes formed on each of the two sheets of transparent substrates and contacting each other when a touch input is applied to sense the change in resistance or voltage; an adhesive layer bonding between the outsides of the two sheets of transparent substrates and having the opening portion formed therein; and a dot spacer formed on the transparent electrode in the opening portion, wherein the transparent electrode formed with the dot spacer includes a radical scavenger. As a result, the present invention provides the touch screen preventing the damage of the transparent electrode due to the ultraviolet rays by using the radical scavenger included in the transparent electrode.

### CROSS REFERENCE TO RELATED APPLICATION

This application claims the benefit of Korean Patent Application No. 10-2010-0084353, filed on Aug. 30, 2010, entitled “Touch Screen,” which is hereby incorporated by reference in its entirety into this application.

### BACKGROUND OF THE INVENTION

1. Technical Field

The present invention relates to a touch screen.

2. Description of the Related Art

As electronic technologies have been continuously developed, personal computers, portable transmitters, or the like, handle texts and graphics by using a variety of input devices, such as a keyboard, a mouse, a digitizer, etc. These input devices, however, have been developed in consideration of the expanding usage of personal computers, such that they are difficult to be applied to portable devices that are recently reduced in size and thickness. Therefore, touch screens are on the rise as an input device appropriate for the portable devices.

Generally, the touch screen, which is a device mounted in the display device to allow a user to select the desired information, has various advantages such as a simple operation, less malfunction, space savings, easy compatibility with IT devices, or the like. Owing to these advantages, the touch screen has been widely used in various fields such as industry, traffic, service, medicine, mobile, and the like.

Meanwhile, the touch screen is classifiable as a resistive type, a capacitive type, an electro-magnetic type, a SAW type, an infrared type, and so on. Among others, the resistive type, which is relatively inexpensive and can accurately detect a position of a touch input, has been prevalently used.

The resistive touch screen according to a prior art includes two sheets of transparent substrates, transparent electrodes formed in each transparent substrate, an adhesive layer bonding two sheets of transparent substrates, and a dot spacer formed in any one of transparent electrodes.

In this configuration, the dot spacer, which is a member mutually insulating the transparent electrodes formed in each of the two sheets of transparent substrates and providing the repulsive force to return the upper transparent substrate to an original position when the touch input is released, is made of a transparent and elastic material. The dot spacer may be formed by first printing the material of the dot spacer on the transparent electrode formed on the transparent substrate and then, irradiating ultraviolet rays (UV) thereto to cure the material of the dot spacer.

However, the touch screen according to a prior art damages the transparent electrode when the dot spacer is cured on the transparent electrode. In detail, since ultraviolet rays are irradiated when the dot spacer is cured on the transparent electrode, there is a problem in that the transparent electrode, such as the rising of the sheet resistance of the transparent electrode due to the ultraviolet rays, etc., is damaged. In particular, when the transparent electrode is made of a conductive polymer, the conductive polymer is further sensitive to ultraviolet rays than indium tin oxide (ITO), such that the sheet resistance is remarkably increased. In addition, the rising of the sheet resistance, etc., causes problems that do not sense whether or not the touch input is applied, the position of the touch input, or the like, even in the entire touch screen.

### SUMMARY OF THE INVENTION

The present invention has been made in an effort to provide a touch screen preventing the phenomenon of when the transparent electrode is damaged by irradiated ultraviolet rays in order to cure the dot spacer on the transparent electrode.

A touch screen according to a preferred embodiment of the present invention includes: two sheets of transparent substrates formed to be opposite to each other; transparent electrodes formed on each of the two sheets of transparent substrates and contacting each other when a touch input is applied to sense the change in resistance or voltage; an adhesive layer bonding between the outsides of the two sheets of transparent substrates and having the opening portion formed therein; and a dot spacer formed on the transparent electrode in the opening portion, wherein the transparent electrode formed with the dot spacer includes a radical scavenger.

The dot spacer may be formed with any one of the transparent electrodes formed on the two sheets of transparent substrates.

The radical scavenger may be HALSs.

In the transparent electrode, the content of the radical scavenger may be 0.1 to 5 wt %.

The transparent electrode may include a conductive polymer.

### BRIEF DESCRIPTION OF THE DRAWINGS

FIG. 1 is a cross-sectional view of a touch screen according to a preferred embodiment of the present invention; and

FIG. 2 is a diagram for explaining a process of curing a dot spacer formed in the touch screen shown in FIG. 1.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

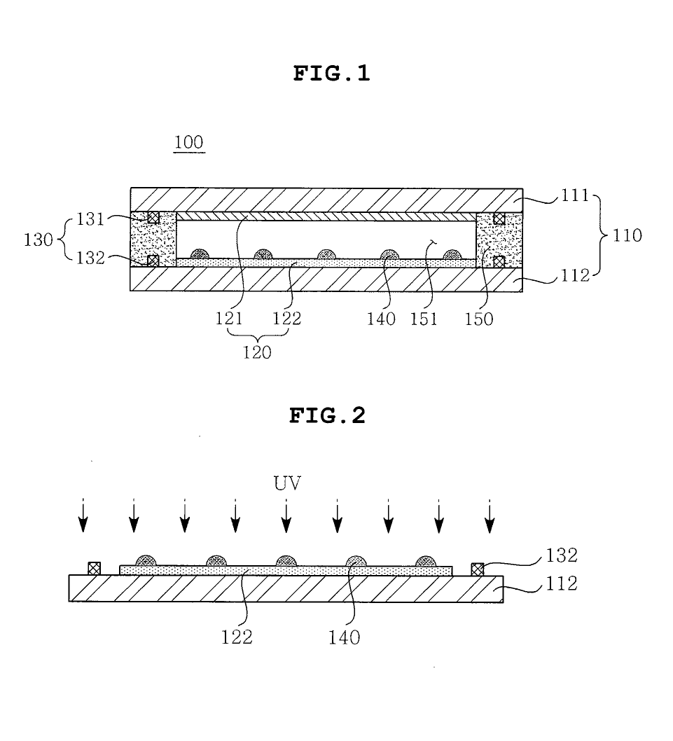

FIG. 1 is a cross-sectional view of a touch screen 100 according to a preferred embodiment of the present invention and FIG. 2 is a diagram of a process of curing a dot spacer 140 formed in the touch screen 110 shown in FIG. 1. Hereinafter, the touch screen 100 according to the present embodiment will be described with reference to FIG. 1.

As shown in FIG. 1, the touch screen 100 according to the preferred embodiment includes a transparent substrate 110, a transparent electrode 120, an electrode 130, an adhesive layer 150, and a dot spacer 140, wherein the transparent electrode 120 formed with the dot spacer 140 is formed with a radical scavenger. The transparent substrate 110 may include two sheets, such as a first transparent substrate 111 and a second transparent substrate 112.

In this configuration, the first transparent substrate 111 is a member receiving pressure from a body of a user or a specific object such as a stylus pen, etc., and one surface thereof is provided with a first transparent electrode 121. In addition, since the first transparent substrate 111 is a member bendable by receiving pressure, it is preferably made of a material having electricity to be again returned to an original position when pressure is released. As an elastic and transparent material, the first transparent substrate 111 may, for example, have a film type made of polyethyleneterephthalate (PET), polycarbonate (PC), polymethylmetacrylate (PMMA), polyethylenenaphthalate (PEN), polyethersulfone (PES) or cyclic olefin copolymer (COC). Besides, glass or tempered glass, which is generally used, may also be used. Meanwhile, the upper portion of the first transparent substrate 111 may be formed with a separate window plate (not shown) to protect the touch screen 100.

The second transparent substrate 112 is a member formed to be opposite to the first transparent substrate 111 and one surface thereof is formed with a second transparent electrode 122. In this configuration, the second transparent substrate 112 may be made of the transparent material similar to the first transparent substrate 111 but does not have elasticity such as the first transparent substrate 111.

Meanwhile, the transparent substrates 110 are each formed with the transparent electrodes 120 and in order to improve adhesion with the transparent electrode 120, it is preferable that one surface of the transparent substrate 110 is subjected to the high frequency treatment or the primer treatment.

The transparent electrode 120 is a member that is formed on each of the transparent substrates 110 to contact each other, thereby recognizing the signal of the touch input.

In this configuration, the transparent electrode 120 may be configured to include the first transparent electrode 121 and the second transparent electrode 122, wherein the first transparent electrode 121 may be formed on the first transparent substrate 111 and the second transparent electrode 122 may be formed on the second transparent substrate 112, so that they are opposite to each other. In addition, the first transparent electrode 121 contacts the second transparent electrode 122 by pressure applied to the first transparent substrate 111 to change voltage or resistance. The pressed coordinates may be recognized in the controller (not shown) based on the change in voltage or resistance and the controller (not shown) recognizes the coordinates of the pressed positions, making it possible to implement the desired operation.

In addition, the first transparent electrode 121 and the second transparent electrode 122 may be formed in a bar type orthogonal to each other to recognize each of the X-axis coordinate and the Y-axis coordinate. However, they are not limited thereto and may be configured in various shapes such as a diamond shape, a hexagonal shape, an octagonal shape, a triangular shape, or the like. In addition, when the transparent electrode 120 is configured in an analog resistive type, it may be formed on the front surface of the transparent substrate 110 in a bar type except for the outside of the transparent substrate 110.

Meanwhile, it is preferable that the transparent electrode 120 is made of a transparent material and a conductive material so that a user can view a display (not shown) disposed thereunder. For example, the transparent electrode 120 may be made of metal oxide such as ITO, etc., or a conductive polymer containing poly-3, 4-ethylenedioxythiophene/polystyrenesulfonate (PEDOT/PSS), polyaniline alone or a mixture thereof. In this case, when the transparent electrode 120 is made of metal oxide, it may be coated on the transparent substrate 110 by deposition, development, etching, etc., and when the transparent electrode 120 is made of a conductive polymer, it may be formed on the transparent substrate 110 through a silk screen printing method, an inkjet printing method, a gravure printing method, an offset printing method, or the like.

In addition, the transparent electrode 120 may be further provided with a radical scavenger and therefore, the contents thereof will be described in detail below.

The electrode 130 is a member that is electrically connected to the transparent electrode 120 and supplies voltage to the transparent electrode 120.

In this configuration, the electrode 130 is configured to include a first electrode 131 and a second electrode 132, wherein the first electrode 131 may be formed to connect to the first transparent electrode 121 on one surface of the first transparent substrate 111 and the second electrode 132 may be formed to connect to the second transparent electrode 122 on one surface of the second transparent substrate 112. In addition, it is preferable that the electrode 130 may be made of a material having excellent electrical conductivity so as to supply voltage to the transparent electrode 120. For example, the electrode 130 may be made of a material containing silver (Ag) paste or organic silver.

The adhesive layer 150 is a member formed at an outer side of one surface of the transparent substrate 110 on which the transparent electrode 120 is formed. In this configuration, the adhesive layer 150 is configured of, for example, a double adhesive tape (DAT), thereby making it possible to bond the first transparent substrate 111 and the second transparent substrate 112 to each other. In addition, the adhesive layer 150 is formed between the outsides of the transparent substrate 110 so that the first transparent electrode 121 and the second transparent electrode 122 may be bonded between the insides of the transparent substrate 110 by the touch input, such that the opening portion 151 may be formed in the adhesive layer 150. Meanwhile, the electrode 130 is formed at the outside of the transparent substrate 110 and may be formed to impregnate in the adhesive layer 150.

The dot spacer 140 is a member formed on the transparent electrode 120 in the opening portion 151 of the adhesive layer 150.

In this case, the dot spacer 140 relieves the impact generated when the first transparent electrode 121 contacts the second transparent electrode 122 and provides repulsive force so that the first transparent substrate 111 is returned to its original position when pressure is released. Further, the dot spacer 140 usually serves to maintain insulation between the first transparent electrode 121 and the second transparent electrode 122 so that the first transparent electrode 121 does not contact the second transparent electrode 122 when there is no external pressure.

In addition, the dot spacer 140 may be formed between the insides of the first transparent substrate 111 and the second transparent substrate 112, that is, in the opening portion 151 of the adhesive layer 150. In this configuration, FIG. 2 shows the case where the dot spacer 140 is formed on only the second transparent electrode 122 but the present invention is not limited thereto. The dot spacer 140 can be formed on only the first transparent electrode 121 or can be formed on both the first transparent electrode 121 and the second transparent electrode 122.

Meanwhile, the transparent electrode 120 formed with the dot spacer 140 may be further provided with the radical scavenger. The preferred embodiment describes, by way of example, the case where the dot spacer 140 is formed in the second transparent electrode 122 and the second transparent electrode 122 includes the radical scavenger.

As shown in FIG. 2, the radical scavenger is included in the second transparent electrode 122, thereby making it possible to prevent the damage of the second transparent electrode 122 during the photo-curing of the dot spacer 140. In detail, ultraviolet rays are irradiated when the dot spacer 140 is cured. The double-bonded ring is broken by forming the radical of the conductive polymer configuring the second transparent electrode 122 due to ultraviolet rays, such that conductivity of the second transparent electrode 122 may be degraded. However, when the second transparent electrode 122 includes the conductive polymer as well as the radical scavenger, the conductivity of the conductive polymer may be maintained by stopping the chain reaction in the phenomenon that the radical scavenger forms the radical of the conductive polymer. That is, in order to cure the dot spacer 140, the sheet resistance of the second transparent electrode 122 may not be increased even though ultraviolet rays are irradiated on the second transparent electrode 122. In addition, when the radical scavenger is included in the second transparent electrode 122, the second transparent electrode 122 can be prevented from being damaged due to the ultraviolet rays input from the outside through the first transparent substrate 111 of the touch screen 100.

Meanwhile, as the UV stabilizer, there are UV absorbent, quencher, radical scavenger, or the like. In this case, in the case of the UV absorbent, it is not suitable for the thin film absorbing the ultraviolet rays or having the thin thickness and in the case of the quencher, it is difficult to apply due to the problem of colorability. In the case of the radical scavenger, since the UV absorber has excellent characteristics and does not have colorability in the film having the thin thickness, it is preferable to be used as a material configuring the second transparent electrode 122.

In addition, as the radical scavenger included in the second transparent electrode 122, it is preferable to use the hindered amine light stabilizers (HALS) in preventing the second transparent electrode 122 from being damaged. As the HALS-based radical scavenger, Tinuvin 292, Tinuvin 770 available from Ciba-Geigy Co, Uvinul 4077 H available from BASF, or Eversorb 93 available from Everlight Co., may be, for example, used.

TABLE 1

| | Content of radical scavenger | Change rate in sheet |
|---|---|---|
| Example | (HALSs) (wt %) | resistance (R/R₀) |
| 1 | 0 | 25% or more |
| 2 | 0.1 | 20% |
| 3 | 1 | 10% |
| 4 | 3 | 5% |
| 5 | 5 | 5% |

Table 1 shows results obtained by comparing the change rate in sheet resistance shown when the radical scavenger is added to the second transparent electrode 122 for each of the contents. Hereinafter, the touch screen 100 according to the preferred embodiment will be described with reference to Table 1. In this case, Table 1 shows results obtained by irradiating ultraviolet rays to the second transparent electrode 122 for 20 seconds at energy of 1840 mJ.

As shown in Table 1, when the radical scavenger is not included in the second transparent electrode 122 (Example 1), the change rate in sheet resistance is 25% or more. For example, when the sheet resistance (R₀) of the second transparent electrode 122 is 100 Ω before the ultraviolet rays are irradiated, the sheet resistance (R) of the second transparent electrode 122 may be 125 Ω or more after the ultraviolet rays are irradiated. The rising of the sheet resistance degrades the sensitivity of the second transparent electrode 122 as well as makes the sheet resistance of the first transparent electrode 121 and the second transparent electrode 122 non-uniform, such that the position of the touch input cannot be accurately sensed.

Meanwhile, as can be appreciated from Table 1, the change rate in the sheet resistance of the second transparent electrode 122 is remarkably reduced as the radical scavenger is added (Examples 2 to 5), which can be appreciated that the weight ratio of the radical scavenger for the conductive polymer configuring the second transparent electrode 122 is up to 5 wt %. Therefore, it is preferable that the weight ratio of the radical scavenger is 0.1 to 5 wt % for the conductive polymer. More preferably, when the radical scavenger is included at 1 to 3 wt %, a large effect can be obtained as compared to the content ratio.

According to the present invention, the touch screen prevents the damage of the transparent electrode due to the rising of the sheet resistance, etc., since a radical scavenger is included in the transparent electrode formed with the dot spacer to stop the chain reaction of a double bonded ring breakage due to the radical formation of the conductive polymer configuring the transparent electrode even though ultraviolet rays are irradiated on the transparent electrode.

In addition, according to the present invention, the touch screen is suitable for a thin film without causing the problem in colorability even though the radical scavenger is included in the transparent electrode.

In addition, the present invention includes the radical scavenger in the transparent electrode to prevent the transparent electrode from being damaged due to the ultraviolet rays input from the outside through the first transparent substrate of the touch screen.

Although the preferred embodiments of the present invention have been disclosed for illustrative purposes, they are for specifically explaining the present invention and thus a touch screen according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen, comprising:
two sheets of transparent substrates formed to be opposite to each other;
transparent electrodes formed on each of the two sheets of transparent substrates and contacting each other when a touch input is applied to sense the change in resistance or voltage;
an adhesive layer bonding between the outsides of the two sheets of transparent substrates and having the opening portion formed therein; and
a dot spacer formed on the transparent electrode in the opening portion,
wherein the transparent electrode formed with the dot spacer includes a radical scavenger.

2. The touch screen as set forth in claim 1, wherein the dot spacer is formed with any one of the transparent electrodes formed on the two sheets of transparent substrates.

3. The touch screen as set forth in claim 1, wherein the radical scavenger is HALSs.

4. The touch screen as set forth in claim 1, wherein in the transparent electrode, the content of the radical scavenger is 0.1 to 5 wt %.

5. The touch screen as set forth in claim 1, wherein the transparent electrode includes a conductive polymer.
